(19) United States
(12) Patent Application Publication
(10) Pub. No.: US 2002/0035489 A1
(43) Pub. Date: Mar. 21, 2002

(54) Foundation funds generation system and method

(76) Inventors: Rosalind Herman, Woburn, MA (US); Gregg Caplitz, Chelsea, MA (US)

Correspondence Address: David M. Mello, McDERMOTT, WILL & EMERY, 28 State Street, Boston, MA, 02109, US

(21) Appl. No.: 09/873,864

(22) Filed: Jun. 4, 2001

Related U.S. Application Data
(60) Provisional application No. 60/208,803, filed on Jun. 2, 2000.
(60) Provisional application No. 60/217,037, filed on Jul. 10, 2000.
(60) Provisional application No. 60/263,288, filed on Jan. 22, 2001.

(51) Int. Cl. G06F 17/60

(52) U.S. Cl. 705/4

(57) ABSTRACT

A method and system is provided for generating funds for a foundation mission statement, such as a charitable or not-for-profit organization or corporation. A set of variable single premium universal life insurance policies are obtained from an insurer on a block of individuals. A lender loans the funds needed to pay the insurance premiums and any other start up costs and first year costs. Over the life of the loan, a re-insurer provides a mortality guarantee, to ensure a minimum stream of death benefits are paid by the insurer. The life insurance premiums are also invested to provide additional earnings. The cash value of the life insurance policies and the reinsurance policy serve as collateral for the loan. A trustee manages the funds held in an escrow account, including making payments to the lender, filing claims, and receipt of death benefits and reinsurance distributions. The foundation is ensured a certain annual cash flow. Once the lender is paid, the foundation receives any residuals funds and cash flow from that point forward, less any related expenses.

### CROSS REFERENCE TO RELATED APPLICATIONS

This application claims the benefit of priority from commonly owned U.S. Provisional Patent Applications Ser. No. 60/208,803, filed Jun. 2, 2000, entitled GENERATING REVENUE USING A LIFE INSURANCE POLICY FUNDING TECHNIQUE, Ser. No. 60/217,037, filed Jul. 10, 2000, entitled GENERATING REVENUE USING A LIFE INSURANCE POLICY FUNDING TECHNIQUE, and Ser. No. 60/263,288, filed Jan. 22, 2001, entitled GENERATING REVENUE USING A LIFE INSURANCE POLICY FUNDING TECHNIQUE.

### FIELD OF THE INVENTION

The present invention generally relates to systems and methods for generating revenue. More specifically, the present invention relates to generating revenue for a charitable foundation using life insurance policies.

### BACKGROUND OF THE INVENTION

Various organizations, such as non-profit and charitable organizations, may have difficulty in funding the organizations. In particular, non-profit organizations may raise funding using techniques relying on labor intensive activities such as reliance on volunteer work or contributions in terms of time and money from, for example, various private corporate sources. For example, non-profit organizations may raise money through fund raising activities and solicitation of a membership base for direct monetary contributions. Fund raising activities may include, for example, raffles, auctions, sponsorship in which a for-profit organization may donate a portion of proceeds to the non-profit organization, and the like.

One technique that a non-profit organization may use to raise money is by taking out life insurance policies on its members with the non-profit organization as the beneficiary. Using this technique, the non-profit organization may take out a loan to fund the annual premiums. This money may be used, for example, to directly pay the premiums, or may alternatively be invested to have a rate of return. A drawback is that the cost of the loan to fund the policies may exceed the financial gain. The cost to the organization may be more than the policy itself in the short term basis, such as annually, creating a short term cash flow problem. The cost may also exceed or significantly reduce the benefit over the long term, such as over the life of a policy. For example, investments of the borrowed money or the cost of the loan itself may exceed the financial benefit received by the organization.

Using a second technique, the non-profit organization may take life insurance policies out on a particular portion of their membership, such as in accordance with age and sex determinations, which the organization believes includes members that are more likely to die than those determined by the actuarial tables. Thus, the organization believes that by targeting this particular portion of the membership, the organization believes that it will achieve a gain greater than if the same money had been spent on funding life insurance policies on a different portion of the membership. One problem with this second technique is the large degree of uncertainty of this greater gain being returned in accordance with this investment strategy. The organization is hypothesizing that a particular portion of their membership based on age and sex yields a higher mortality rate. If this is true, the insurance company will most likely raise the annual premiums. Another drawback is that if borrowed money is used, the cost incurred in borrowing the money may exceed or significantly reduce the actual financial benefit that the organization realizes.

Thus, it may be desirable to have a life insurance policy finding technique that generates revenue with a higher degree of certainty without the drawbacks of the foregoing and provides for increased cash flow in both the long term and short term for the organization.

### SUMMARY OF THE INVENTION

The present invention is a foundation funds generation system and method that accomplishes immediate and long term financial gains for a foundation, such as a charitable foundation or not-for-profit corporation or other such organization. In the preferred form, the foundation funds generation system and method use foundation owned life insurance to generate funds. Individual supporters of the foundation are grouped together in one or more blocks and insurance policies are taken out on the group for the benefit of the foundation. Typically, the funds needed to purchase the insurance policies are provided by one or more lenders or investors. However, if the foundation has sufficient resources, the foundation may provide some or all of the funds required to purchase the block of life insurance policies. The insurance policies provide a source of revenue sufficient to repay the lender(s) or investor(s) and to finance a specific mission statement of the foundation. A mission statement can be any defined and planned project (or mission) requiring funds.

A program manager may be used to facilitate the creation and implementation of the foundation funds generation system and method. In such a case, a large block of individuals (e.g., 5,000 individuals) is defined by or on behalf of the foundation. The program manager obtains financing from a lender to procure a set of life insurance policies on the block of individuals. Preferably, the life insurance policies are variable single premium variable life insurance policies, with a single premium due at policy issuance. The lender provides a loan sufficient to pay the insurance premiums and an installation fee (if required), as well as any other start up costs or first year costs. As an example, the loan may be a below market rate loan, with deferred payment of the principle, and equity supplements also paid to the lender near the end of the life of the loan. Interest payments are made from the start of the loan to the time of payment of the principle.

The insurance policies serve as collateral to the lender for the loan. The insurance premiums are invested in traditional securities to generate an investment return, so that the cash value associated with the policies increases with time. A predetermined cash flow is guaranteed to the foundation by the program, as a function of the number of lives insured, for example. Loan payments are made to the lender from the life insurance policy death benefit proceeds and, as needed, from guaranteed mortality reinsurance payments. A trustee holds the insurance policies on behalf of the foundation and files death benefit (or life insurance policy) claims. A re-insurer issues the mortality guarantee reinsurance policy to compensate for any shortfalls in death benefit pay-outs from the insurer, thereby protecting the lender by ensuring a minimum level of overall insurance proceeds. The re-insurance policy acts as collateral for the loan, so need only be in effect until the lender is paid in full. However, the foundation may choose to continue the reinsurance policy even after the obligations to the lender have been satisfied.

The trustee handles the majority of payments and receives distributions associated with the program. Death benefits are distributed from the insurer to the trustee and held in a trustee managed escrow account. Similarly, reinsurance payments are also made to the trustee and held in the escrow account. The trustee may, optionally, invest some or all of the escrowed funds in no-risk securities. From the escrow account, the trustee makes loan payments to the lender and pays any other necessary expenses and fees, such as a trustee's fee. Loan payments may include one or more interest payments, principle payments, and/or equity supplement payments. The premiums for the reinsurance policy are also paid from the escrow account by the trustee.

Once the lender is paid in full, any escrow account residuals may be provided to the foundation, less any related expenses. For example, if the trustee is maintained beyond the life of the loan and reinsurance policy, a trustee fee continues to be paid. Also, if the program manager is maintained, a management fee continues to be paid.

The foundation funds generation system and method may be implemented on a computer system, wherein each entity may have a system capable of accessing or being accessed via a network, such as the Internet, by the other entities' systems. In such a case, functional modules are loaded on the respective systems to facilitate accomplishment of each entity's role, including the electronic distribution or transfer of funds among some or all of the entities.

The program manager may keep a database of lenders, trustees, insurers, and re-insurers qualified and willing to participate in such programs. In such a case, a program manager system may accommodate selection from the database of one or more lenders, trustees, insurers, and re-insurers on behalf of a foundation, to implement a specific foundation program.

### BRIEF DESCRIPTION OF THE DRAWINGS

The foregoing and other objects of this invention, the various features thereof, as well as the invention itself, may be more fully understood from the following description, when read together with the accompanying drawings, described:

FIG. 1 is a block diagram showing various entities and their relationships as a foundation funds generation system and method. in accordance with the present invention;

FIG. 2 is a chart showing the roles of the entities of FIG. 1;

FIG. 3 is a block diagram showing the management of a separate investment account by the program manager and insurer of FIG. 1;

FIG. 4 is a block diagram showing the management of an escrow account by the trustee of FIG. 1;

FIG. 5 is a top level architecture that may be implemented by the entities of FIG. 1; and

FIG. 6 is a block diagram of various functional modules that may be implemented on the architecture of FIG. 5, in accordance with the present invention.

For the most part, and as will be apparent when referring to the figures, when an item is used unchanged in more than one figure, it is identified by the same alphanumeric reference indicator in all figures.

### DETAILED DESCRIPTION OF THE PREFERRED EMBODIMENT

The present invention is a foundation funds generation system and method that accomplishes immediate and long term financial gains for a foundation, such as a charitable foundation or not-for-profit corporation or other such organization. In the preferred form, the foundation funds generation system and method use foundation owned life insurance to generate funds. Individual supporters of the foundation are grouped together in one or more blocks and insurance policies are taken out on the group for the benefit of the foundation. Typically, the funds needed to purchase the insurance policies are provided by one or more lenders or investors. However, if the foundation has sufficient resources, the foundation may provide some or all of the funds required to purchase the block of life insurance policies. The insurance policies, mortality payments, and/or reinsurance payments provide a source of revenue sufficient to repay the lender(s) or investor(s) and to finance a specific mission statement of the foundation. A mission statement can be any defined and planned project (or mission) requiring funds to meet a foundation objective.

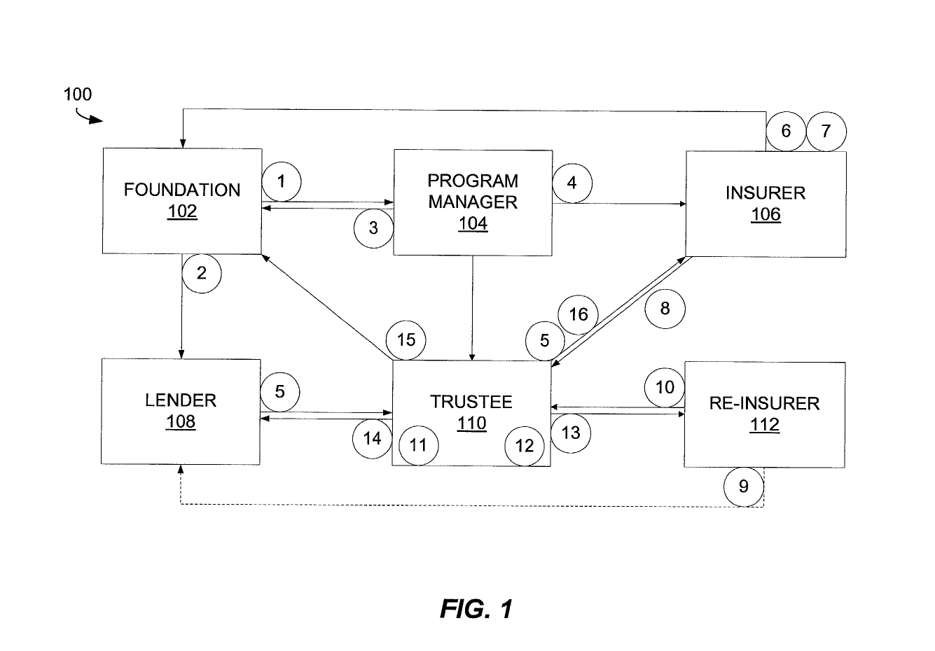

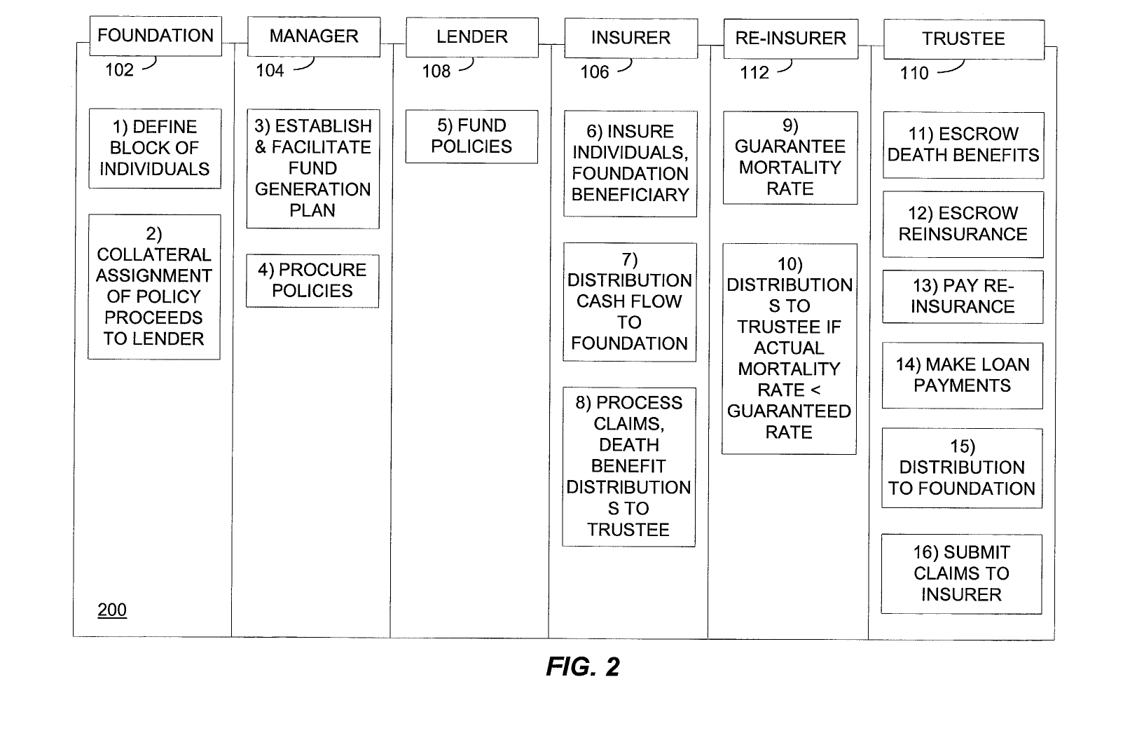

In the preferred embodiment, the foundation funds generation system and method is implemented as a program that involves several entities, wherein each entity may have one or more of a variety of roles. For example, FIG. 1 shows a set 100 of preferred entities and FIG. 2 shows a chart 200 of the roles of each entity. The various roles from FIG. 2 are shown as circled numbers in FIG. 1, to indicate the relationships among the entities. A Foundation 102 is the organization that serves as the primary benefactor of the foundation funds generation system and method. Although, as will be discussed in further detail below, the present invention provides financial rewards for a variety of involved entities. Preferably, Foundation 102 is a charitable or not-for-profit organization. Such organizations typically provide great benefits to society, but often have relatively modest financial resources. In other embodiments, the present invention may be implemented for the benefit of other types of organizations (e.g., for profit organizations, trusts, and so on). However, typically there are certain tax related benefits to such a program that may not be available to organizations that do not have the status of a charitable or not-for-profit organization.

Referring to FIG. 1 and FIG. 2, a block of individuals is defined by (or on behalf of) Foundation 102. In the preferred form, each individual in the block of individuals assents to have a life insurance policy taken out in his or her name for the benefit of Foundation 102. Preferably, Foundation 102 is at least a 90% named beneficiary with the individual naming the beneficiary of the remaining 0-10%, for example. In some embodiments, the Foundation 102 may be the only named beneficiary, and in other embodiments Foundation 102 may be less than a 90% beneficiary. In the preferred form, the block of individuals includes at least 5,000 individuals within the age range of 25 years old to 70 years old. Smaller or larger blocks of individuals may also be defined, so long as the block of individuals provides acceptable risk reward for the various entities involved, and sufficient proceeds to fund Foundation 102's mission statement.

Generally, a block of at least 5,000 individuals provides a relatively stable and predictable stream of funds with low risk, as will be appreciated by those skilled in the art. Also, including individuals from such a large age range (i.e., 25-70 years of age) better ensures a predictable mortality rate, which causes a relatively predictable stream of death benefits from the insurance policies. Although, other age ranges may defined; there is no inherent limit on the age range, but a relatively even distribution over a large range is preferred. Additionally, given the difference in mortality rates for men and women, the age range for men and women may be different. Also, age ranges may take into account health or lifestyles, such as smokers and non-smokers.

A Program Manager 104 may serve as an entity that originates a foundation funds generation system and method and performs overall administration of the program on behalf of Foundation 102. Program Manager 104 may be a separate entity engaged in implementing the present invention on behalf of the Foundation. Although, Program Manager 104 need not be exclusively engaged in such business. For example, the Program Manager 104 may be an insurance company, trust company, or investment company, a financial institution, or Foundation 102 may serve as Program Manager. Once a block of individuals has been defined, Program Manager 104 procures insurance for the block of individuals from an Insurer 106. As an example, Insurer 106 may be Ameritas General Life Insurance Company. Generally, Insurer 106 should have a high ability to pay claims, as indicated by having a high industry rating, such as an AA+ repayment rating from Standard & Poors or Duff & Phelps.

The funds used to procure the insurance policies are provided by a Lender 108. The loaned funds may be provided to Program Manager 104 or a Trustee 110, which in turn pays Insurer 106. The funds required may include, for example, all insurance premiums and an Insurer 106 installation fee, among other fees and costs. For example, the total loan amount may be:

TOTAL LOANAMOUNT=COST OF LOAN FEE+POLICY PREMIUMS+INSTALLATION FEE+1st YEAR TRUSTEE FEE+1st YEAR REINSURANCE PREMIUM+1st YEAR MANAGER FEE+INITIAL ESCROW AMOUNT

A program amount may be defined as the total loan amount less the cost of the loan. In the example discussed with respect to Appendix A and Appendix B, the program amount is $500M. In the preferred embodiment, the cost of loan fee is defined as 2% of the program amount+origination fee, wherein the origination fee may be 0.2% of the program amount. Again, in the example of Appendix A and Appendix B, 2% of the program amount is $10M and 0.2% of the program amount is $100K, yielding a cost of loan of $10.1M. Lender 108 preferably makes a loan to Foundation 102 that is, at least in part, collateralized by the insurance policies.

In the preferred form, the loan is established as a 20 year loan with only interest payments due each year from year 1 through year 17. By the close of year 17 the principle loan amount is due and in years 18, 19, and 20 equity supplements are paid to Lender 108. The equity supplements are predetermined, typically as a percentage of the total loan amount (i.e., principle), and assist in creating an incentive for Lender 108 to provide the loan, preferably at a below market rate. Beyond year 20, Lender 106 receives no further payments and Foundation 102's obligation to Lender 108 are satisfied. The equity supplement for each of years 18, 19, and 20 may be determined by the following equation:

SUPPLEMENT=TOTAL LOAN AMOUNT*SUPPLEMENT PERCENTAGE

Of course, other loan structures and terms may be used and a variety of manners of creating an incentive for Lender 108 may be implemented. The key elements of the arrangement between Foundation 102 and Lender 108 allow Lender 108 to receive sufficient risk reward to make a loan of sufficient amount and at a sufficient interest rate to Foundation 102, such that Foundation 102 can procure the block of insurance policies, make any necessary payments, and generate a desired annual return for at least a desired period of time (e.g., the loan term and beyond) to fund Foundation 102's mission statement.

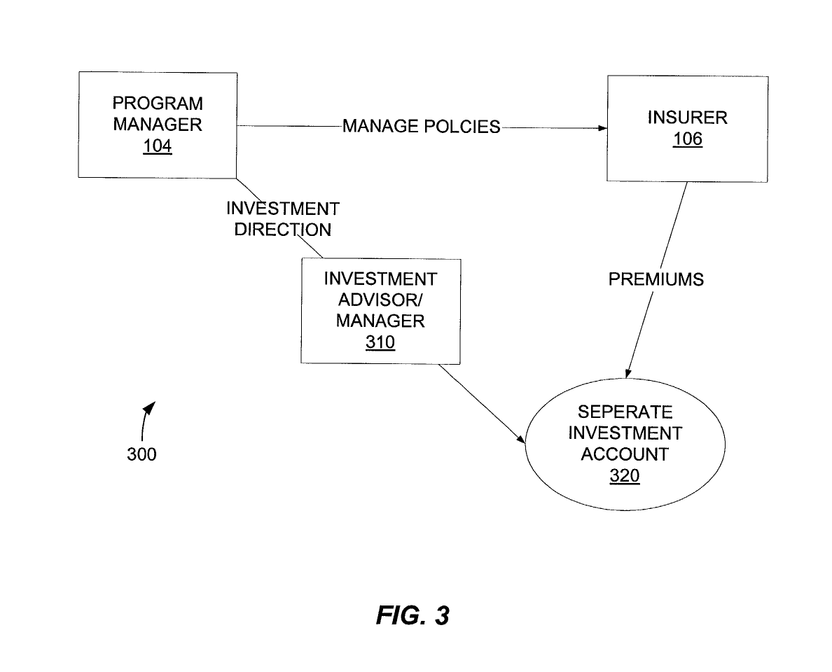

In the preferred form, the insurance policies are variable single premium universal life insurance policies having a single payment due upon issuance of the policy. Preferably, they are also non-commissioned policies, so as not to deplete the financial gains of Foundation 102. Typically, an insurer invests the premiums in market securities, such as bonds, stocks, mutual funds or some combination thereof. In that regard, the premiums may be placed in a separate (premium) investment account for investment (see FIG. 3). Therefore, the premiums earn some market rate of return for Insurer 106.

As shown in the separate investment account flow diagram 300 of FIG. 3, the insurance premiums may be managed in the separate account 320 under, to some degree, control of Program Manager 104. Program Manager 104 may optionally utilize an asset management firm 310, such as Merrill Lynch Asset Management, Inc., to advise and/or invest funds from separate investment account 320. The value of separate investment account 320 may be in accordance with the following formula:

ENDING SEPARATE ACCOUNT BALANCE=INITIAL SEPARATE ACCOUNT VALUE+INVESTMENT PERFORMANCE−POLICY CHARGES−M & E CHARGES−ANNUAL FOUNDATION DISTRIBUTIONS

The initial separate account value is the initial premium deposit. Policy charges may include such things as taxes and “mortality costs”, which is the Insurer's charge of a cost per $1,000 of death benefits. Mortality costs are the costs to find the death benefit pay-outs. Investment performance is the return on investment of the funds in the separate investment account 320. M & E (or mortality and expenses) charges are internal Insurer charges for policy administration and other internal policy costs. And, annual distributions are the guaranteed annual cash flow to Foundation 102.

The variable single premium universal life insurance policies used in the preferred embodiment have a cash value (CV), which increases with time for policies that have yet to pay death benefits. The increase is a function of the return on investment of separate investment account 320. Accordingly, the CV serves as collateral to Lender 108 for the loan. In the preferred form, Foundation 102 is guaranteed a cash flow of $100,000 per 1,000 lives insured, which is provided by Insurer 106 from the separate account 320. Therefore, as long as there are at least 1,000 individuals from the block of 5,000 individuals alive, $100,000 is paid to Foundation 102 by Insurer 106. Payments to Foundation 102 may be made directly to the foundation or, in other embodiments to Trustee 110 or Program Manager 104 on behalf of Foundation 102.

Since a certain amount of the long term financial planning and the ability to make payments to Lender 108 is contingent on a certain amount of death benefits being paid each year over the course of the loan period, here 20 years, a “mortality guarantee” is procured on behalf of Lender 108 from a Re-insurer 112. The mortality guarantee serves as the primary collateral for the loan. Under the mortality guarantee, if insufficient death benefits are paid in a given year by Insurer 106 (i.e., fewer individuals died during a given year than expected), Re-insurer 112 is liable to make up the short coming in death benefits, thus reducing default risk to the Lender 108 by Foundation 102. Re-insurer 112 makes reinsurance payments to the Trustee 110, which are added to the escrow account. Trustee 110 is then assured of having sufficient to funds in the escrow account to make timely payments to Lender 108.

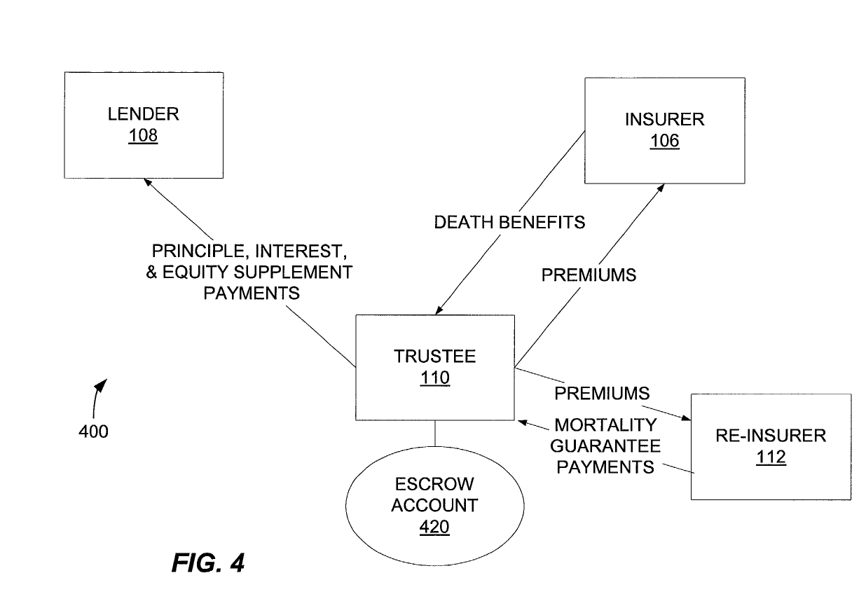

Preferably, Trustee 110 is a nominee trustee, such as the New York Trust Company of Florida, N.A. Trustee 110 handles the majority of the on-going financial transactions and distributions and manages the escrow account 420, as is shown in the block diagram of FIG. 4. Trustee 110 holds the insurance policies and files death benefit claims on behalf of Foundation 102. From Insurer 106, Trustee 110 receives death benefit pay-outs on life insurance claims. Payment of re-insurance premiums are made by Trustee 110 to Re-insurer 112 from escrow account 420, as are annual interest payments, the principle payment, and the equity supplement payments to Lender 108. Any residual escrow amounts may be distributed to Foundation 102 by Trustee 110 from escrow account 420, after the obligations to lenders are complete. In some embodiments, Insurer 106 could make its cash flow payments to Foundation 102 via Trustee 110 (or via Program Manager 104). Typically, Trustee 110 is paid a fee for its services, also taken from escrow account 420. Trustee 110 may invest some or all of the escrow account in no-risk investment vehicles.

The escrow account 420 balance, managed by Trustee 110, may be appreciated by the following equation:

ESCROW ACCOUNT BALANCE=INITIAL ESCRO WDEPOSIT+DEATH BENEFITS+MORTALITY GUARANTEE PAYMENTS+ESCROW INTEREST−LOAN PRINCIPLE PAYMENTS−LOAN INTEREST PAYMENTS−EQUITY SUPPLEMENT PAYMENTS−TRUSTEE FEE

The initial escrow account deposit is paid from residuals from the loan. That is, the loan amount is intentionally made greater than the amount needed to pay insurance premiums and installation fee The initial escrow account deposit seeds the escrow account with additional funds to cover such expenses as an initial reinsurance premium, initial Trustee 110 fee, and initial Program Manager 104 fee. These escrows lower the risk to Lender 108. As previously mentioned, death benefits are also paid to Trustee 110 by Insurer 106, in response to the filing of a claim by Trustee 110. Mortality guarantee (or reinsurance) payments come to Trustee 11 0 from Re-insurer 112, also as previously mentioned. A management fee (not shown in the equation above) may also be paid to Program Manager 104 from escrow account 420.

A specific implementation of the foundation finds generation system and method may be appreciated with respect to Appendices A-B, which provide a sample implementation of the foundation funds generation system and method. Appendix A provides an analysis of the CV required rate of return for years 1-20, assuming a 20 year loan. These figures can be better appreciated with respect to the program overview of Appendix B. In this example, the block of individuals is 20,000 people and the program value (or amount) is $500,000,000. The program value includes the cost of the premiums to insure those individual's lives of $479,900,000 (column 3) and the installation fee of $8,000 (column 5), and the initial deposit to the escrow account, to make $500M. A cost of loan fee (or “raise”) is $10,100,000, making the total loan value $510,100,000 (columns 2 & 4), as previously described. There is a $0 down payment and the Lender 108 gives a 6.0% interest rate.

Column 6 of Appendix B shows the policy value (or CV) increasing each year. A reinsurance premium of $32,000 per 1,000 lives insured (here 20,000 lives) is paid annually (columns 9 & 10) to Re-insurer 112. In column 7, the amount of reinsured mortality is shown for years 1-20, and the actual mortality is shown for years 20-40 (assuming that it is known). Since reinsurance is only required during the loan term, i.e., years 1-20, the cumulative reinsured mortality is only shown for that period, and reinsurance premiums are not paid beyond year 20.

The loan interest is shown as $30,606,000 for years 1-17. The principle amount of $510,100,000 is paid in a lump sum to Lender 108 at the close of year 17. Since no principle is paid in years 1-17 (until the end of year 17), the interest is the same amount each year, figured at 6.0%. In this example, Trustee 110 takes an annual fee of $10,000 for years 1-40, for example, assuming a program life of 40 years. Trustee 110 is needed for at least years 1-20, while Lender 108 and Re-insurer 112 require payments. In this example, the equity supplement paid to Lender 108 is $42,491,330 in each of years 18, 19, and 20. After all required initial payments are made, the initial escrow balance in year 1 is $21,560,000. A distribution of $2,000,000 is made to Foundation 102 (given 20,000 lives insured).

The adjusted CV of the policies is shown as $482,069,795 which is determined by:

ADJUSTED CV=CV−LOAN PAYOUTS+INVESTMENT RETURNS

The value of the collateral is $503,629,795, given by:

COLLATERAL VALUE=ESCROW BALANCE+ADJUSTED CV

A surplus/deficit is given as the difference between the outstanding principle and the collateral value, or:

SURPLUS/DEFICIT AMOUNT=LOAN PRINCIPLE−COLLATERAL VALUE

This value is shown as −$6,470,205 in year 1, but goes positive (i.e., a surplus) in year 2 at $46,282,219 and stays positive from that point forward.

Appendix B also shows the internal rate of return (IRR) cash inflows/outflows, in year 1 the figures is −$478,340,000, which yields an IRR in year 1 of −0.9888%. This value is arrived at as follows:

IRR CASH INFLOWS/OUTFLOWS=DEATH BENEFITS+ESCROW BALANCE−LOAN PRINCIPLE

The IRR of the life of the program is 8.1830%.

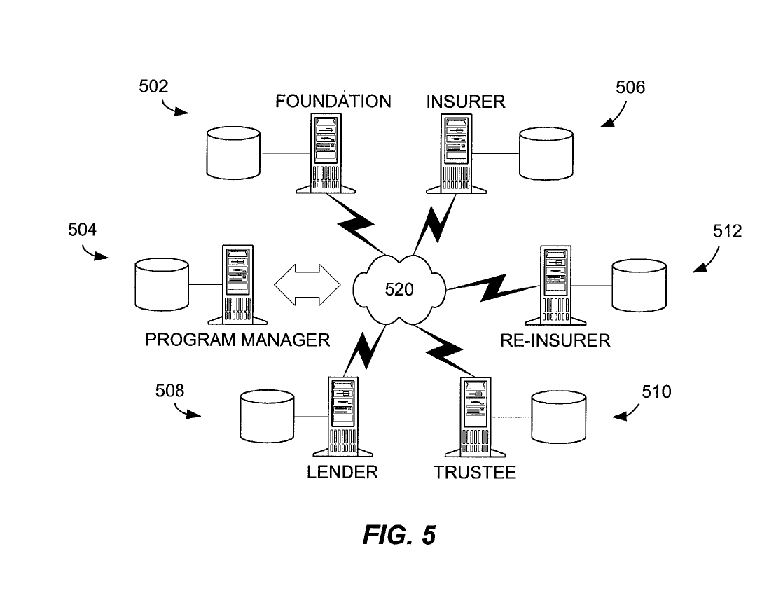

The present invention may be implemented on a networked computer system that is accessible by a variety of entities involved, as is shown in FIG. 5. In FIG. 5, each entity is shown having its own system, wherein a foundation system 502 may selectively access a network 520, such as the Internet, to accomplish its roles. A program manager system 504, insurer system 506, lender system 508, trustee system 510 and re-insurer system 512 may also be included. These individual computer systems may be coupled together to facilitate transactions, management, distributions, payments, coordination, investing, insurance claim processing and so forth.

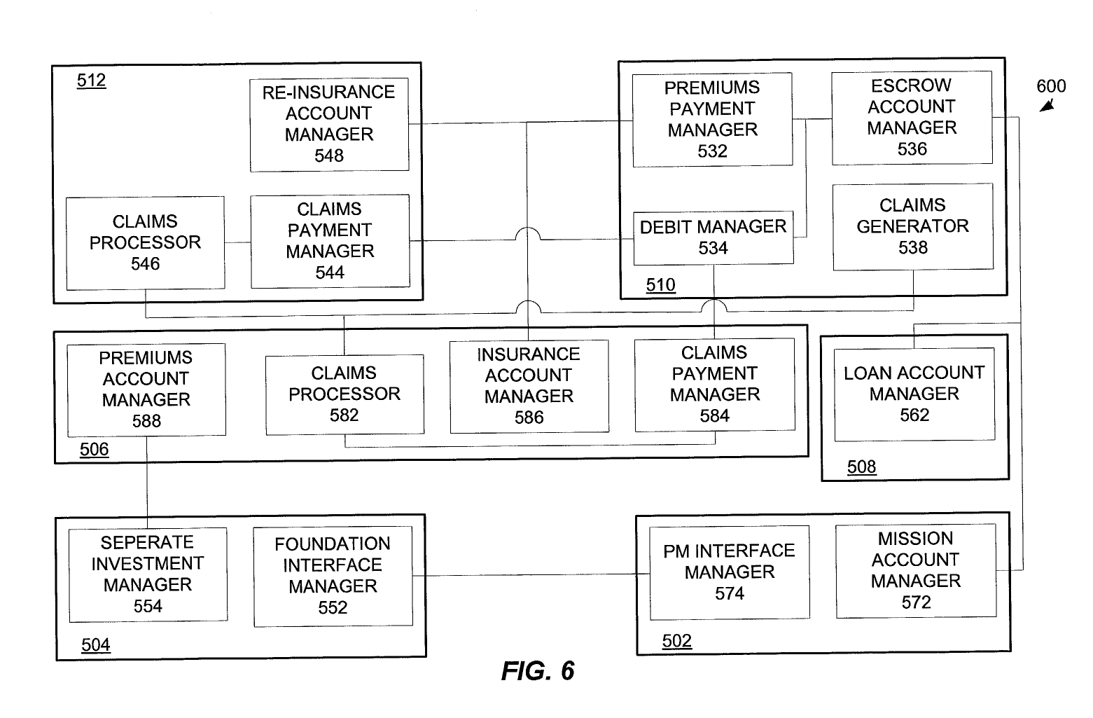

In FIG. 6, a set of functional modules corresponding to the roles of FIG. 2 is loaded on the respective entities' computer systems. For example, foundation system 502 may include a mission account manager 572 that manages the funds received, and potentially other mission resources (e.g., schedules). A program manager (PM) interface 574 may also be included that facilitates the exchange of information between Foundation 102 and Program Manager 104. For example, Program Manager 104 may provide status reports to Foundation 102. Accordingly, program manager system 504 includes foundation interface manager 552. For management of the separate investment account 320 (see FIG. 3), program manager system 504 also includes a separate investment account manager 554 that may include links to an asset management company handling investment of funds. The separate investment account manager 554 also links to a premiums account manager 588 of insurer system 506, wherein the premiums are held.

Lender system 508 includes a loan account manager 562 configured to receive and/or process loan payments (i.e., principle, interest, and equity supplement payments) against the loan. Such payments may be accomplished by electronic transfer, as is true of all of the various funds transfers among the entities. Escrow system 510 also includes a premiums payment manager 532 configured to pay premiums to Insurer 106, via insurance account manager 586 of insurer system 506, and reinsurance premiums via the re-insurance account manager 548 of the re-insurer system 512. claims payment manager 584 of insurer system 506 pays death benefits to trustee system 510 trustee account manager 536 via debit manager 534. claim processor 582 of the insurer system 506 pays claims filed by the claims generator 538 of the trustee system 510. Similarly, the claims processor 546 of re-insurer system 512 processes claims submitted by claims generator 538 of trustee system 510, wherein a claims payment manager 544 pays claims to trustee system 510. As will be appreciated by those skilled in the art, the modules and systems described herein are merely illustrative, and the present invention may be embodied in other architectures having similar functionality.

The program manager system 504 may maintain or access a database of lenders, trustees, insurers, and re-insurers qualified and willing to participate in such programs. In such a case, program manager system 504 may accommodate selection from the database of one or more lenders, trustees, insurers, and re-insurers on behalf of a foundation, to implement a specific foundation program. The program manager may include a search engine that provides a recommended one of each of the above entities. Such selection may based on one or more of a variety of program manager defined selection criteria, such as industry ratings, past performance, interest rate offerings, lowest fees, or other economic criteria.

The invention may be embodied in other specific forms without departing from the spirit or central characteristics thereof. The present embodiments are therefore to be considered in all respects as illustrative and not restrictive, the scope of the invention being indicated by appending claims rather than by the foregoing description, and all changes that come within the meaning and range of equivalency of the claims are therefore intended to be embraced therein.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for generating funds for a foundation, comprising:
A. insuring a block of individuals with a set of life insurance policies and naming said foundation as a beneficiary of said insurance policies;
B. funding said life insurance policies by a third party with an amount at least as great as corresponding life insurance premiums;
C. investing a substantial portion of said premiums and obtaining an investment return and defining a cash value from said premiums and said investment returns;
D. paying death benefits by said insurer on deceased individuals from said block of individuals;
E. guaranteeing a mortality rate, wherein if an actual mortality rate is lower than a projected mortality rate, a re-insurer makes one or more reinsurance payments under a reinsurance policy to compensate for a corresponding shortfall in death benefits;
F. paying said foundation at least a minimum annual cash flow for a program period from said cash value; and
G. repaying said third party amount and paying premiums for said reinsurance policy from said death benefits and said reinsurance payments.

2. A method as in claim 1, wherein said life insurance policies are variable single premium universal life policies, wherein the single premiums are due at issuance of said life insurance policies.

3. A method as claim 1, where in said block of individuals includes about 5,000 or more individuals.

4. A method as in claim 1 wherein an age range of said individuals is from about 25 years of age to about 70 years of age.

5. A method as in claim 1, wherein said third party amount is a loan taken from a lender for a loan term, wherein said loan term is not greater than said program period and said loan term includes a first period and a second period, wherein loan interest are made payments to said lender through said first period, a loan principle payment is made to said lender at a close of said first period, and equity supplements are paid to said lender during said second period.

6. A method as in claim 5, wherein said loan term is 20 years, said first period is years 1-17 and said second period is years 18-20.

7. A method as in claim 1, wherein said reinsurance payments and said death benefits are held in an escrow account managed by a trustee.

8. A method as in claim 7, wherein said trustee is a nominee trustee that holds the life insurance policies and files death benefit claims against said life insurance policies.

9. A method as in claim 7, wherein said escrow account is seeded with an initial escrow amount that is at least as great as a first year's interest on said third party amount, a first year's reinsurance premium, and a first year's trustee fee.

10. A method as in claim 1, further including paying from said third party amount start-up costs, including an insurance installation fee and a first year reinsurance premium.

11. A method as in claim 1, wherein a program manager obtains said lender, said insurer, and said re-insurer on behalf of said foundation.

12. A method as in claim 1, wherein a program manager manages said investing of a substantial portion of said premiums.

13. A method as in claim 1, wherein said foundation is at least a 90% beneficiary of said set of life insurance policies.

14. A method as in claim 1, wherein said third party amount is collateralized by one or more of said reinsurance policy and said life insurance policies.

15. A method for generating funds for a charitable foundation, comprising:
A. defining a block of individuals associated with said foundation;
B insuring said block of individuals with a set of single premium universal life insurance policies provided by an insurer, wherein said foundation is a beneficiary of said life insurance policies and funds provided by a lender are used to pay premiums, start-up costs and first year costs associated with procuring said life insurance policies;
C. collaterally assigning said life insurance policies to said lender, until such time as said lender is paid in full;
D. paying death benefits from said life insurance policies to a nominee trustee, wherein said trustee holds said life insurance policies and manages said death benefits in an escrow account;
E. investing at least a portion of said premiums to obtain an investment return, and defining a cash value associated with said life insurance policies that includes said premiums and said investment return;
F. guaranteeing, by a re-insurer, a minimum amount of death benefits from said insurance policies as a function of a projected mortality rate, and paying a reinsurance payment to said trustee managed escrow account that is equal to a shortfall in death benefits when an actual mortality rate is less than said projected mortality rate;
G. distributing a series of loan payments to said lender from said escrow account, until said loan is paid in full, wherein each of said series of loan payments includes at least one of an interest payment, a principle payment, or an equity supplement payment; and
H. distributing to said foundation a guaranteed annual cash flow from said cash value.

16. A method as in claim 15, wherein said life insurance policies are single premium universal life policies and said foundation is at least about a 90% beneficiary of said life insurance policies.

17. A method as in claim 15, wherein said block of individuals is at least about 5,000 individuals.

18. A method as in claim 15, wherein said loan is taken for a loan term, wherein said loan term includes a first period and a second period and loan interest payments are made to said lender through said first period, a loan principle payment is made to said lender at a close of said first period, and equity supplements are paid to said lender during said second period.

19. A method as in claim 18, wherein said loan term is 20 years, said first period is years 1-17 and said second period is years 18-20.

20. A system for generating funds for a charitable foundation, said system comprising:
A. an insurer system having an insurance policy processor, configured to generate a set of single premium life insurance policies for a block of individuals for the benefit of said foundation and further configured to process claims against said policies, wherein said insurance policy processor includes a claims payment manager configured to distribute death benefits in response to receipt of valid life insurance claims;
B. an investment account manager, configured to invest a substantial portion of said premiums to generate investment returns, wherein said insurer system determines a cash value associated with said life insurance policies that includes said premiums and said investment returns;
C. a lender system, configured to generate a loan of sufficient amount to pay premiums associated with said life insurance policies and a set of startup costs, including first year costs;
D. a re-insurer system, configured to manage a reinsurance policy that guarantees a minimum amount of death benefits from said life insurance policies, wherein said re-insurer system generates and distributes a re-insurance payment in an amount equal to a shortfall in said death benefits, in response to an actual mortality rate being less than a projected mortality rate;
E. a trustee system configured to manage an escrow account, including:
i) a debit manager configured to add said death benefit distributions and said reinsurance payments to said escrow account; and
ii) a payment manager configured to distribute a series of loan payments to said lender system, reinsurance premiums to said re-insurer system; and
F. a cash flow generator configured to distribute a predetermined annual cash flow to said foundation.

21. A system as in claim 20, wherein said first year costs include a first year reinsurance premium, a first year trustee fee, and a first year interest payment on said loan.

22. A system as in claim 20, wherein said first year costs are used to seed said escrow account.

23. A system as in claim 20, wherein two or more of said insurer system, said re-insurer system, said trustee system, and said lender system are coupled together via a network.

24. A system as in claim 20, wherein at least some of said death benefit distributions, said re-insurance payment distributions, said investment return distributions, said loan payments, said reinsurance premium payments, and said annual cash flow to said foundation are accomplished by electronic finds transfer via said network.

25. A system as in claim 20, wherein a program manager system includes said separate investment account manager coupled to said investment account manager and configured to manage the investment of said premiums.

26. A system as in claim 20, further comprising a program manager system configured to facilitate selection of an insurer from a candidate set of insurers, a trustee from a set of candidate trustees, a lender from a candidate set of lenders, and a re-insurer from a candidate set of re-insurers, on behalf of said foundation.

27. A system as in claim 20, wherein said series of loan payments includes at least one of an interest payment, a principle payment, or an equity supplement payment.

28. A system as in claim 20, wherein said trustee system is configured to terminate said reinsurance policy upon satisfaction of payment obligations to said lender.

29. A system as in claim 20, wherein said insurer system comprises said investment account manager and said cash flow generator.
